(19) United States
(12) Patent Application Publication
(10) Pub. No.: US 2002/0177236 A1
(43) Pub. Date: Nov. 28, 2002

(54) Mold detection kit

(76) Inventor: Susan Flappan, Overland Park, KS (US)

Correspondence Address: Michael Yakimo, Jr., Chase Law Firm, L.C., Suite 130, 4400 College Boulevard, Overland Park, KS, 66211, US

(21) Appl. No.: 10/058,595

(22) Filed: Jan. 28, 2002

Related U.S. Application Data
(60) Provisional application No. 60/292,775, filed on May 22, 2001.

(51) Int. Cl. G01N 1/00

(52) U.S. Cl. 436/174; 422/61; 435/4

(57) ABSTRACT

A test kit for collection of an environmental sample for subsequent analysis comprises a test tape and a microscopic-type slide releasably attached to a mailing placard. The tape has a releasable adhesive on one side thereof with a window therein. Upon removal of the tape from the slide the window is pressed against the sample. A grid within the window enhances location and viewing of the specimen affixed within the window. Upon reattachment of the tape to the slide, the placard is transported for subsequent microscopic analysis. Upon release from the placard, the slide is ready for microscopic viewing. The placard includes indicia thereon for a desired alignment of the test tapes on the slide. The tape includes an adhesive free tab for enhancing handling.

### CROSS REFERENCE TO RELATED APPLICATION

This application claims the benefit of a prior filed, co-pending application Ser. No. 60/292,775, filed May 22, 2001, entitled MOLD DETECTION KIT.

### BACKGROUND OF THE INVENTION

This invention pertains to a mold detection kit and, more particularly, to an improved kit presenting an efficient, reliable system for collecting mold samples, sample transport and laboratory analysis.

Heretofore, one method for collecting mold samples used a roll of one-sided transparent sticky tape, such as Scotch® tape or the like. The user would press a non-standardized section of the tape on the unidentified mold or surface dust. The mold or surface dust, stuck to the tape, would then be placed into a Ziploc® baggie and sent to the laboratory for analysis. One problem with this procedure was the lack of standardization of the size of tape used or the area of deposition. Additionally, there was no specific structure on the tape for locating the mold sample thereon. Moreover, at the laboratory the tape needed further processing for microscopic viewing. Part of this processing would entail removing the tape from the baggie, which might cause the tape to tear or leave some material behind, compromising the integrity of the sample. Additionally, the size of the piece of tape would not be an appropriate sample (too large) and the laboratory would have to arbitrarily select which portion of the tape to read. Because the sample was not homogenous (there can be several different molds present in any surface area with mold growth), important information might be missed due to the selection choice. Furthermore, manipulation and cutting of the selected area of tape might result in exposure to toxic constituents on the piece of tape.

Another mold collection method utilized a plurality of precut tapes releasably attached to a large piece of plastic that was used solely as a means of transport. Upon collection of the mold sample on the sticky side of the tape, the tape was releasably affixed to the plastic and sent to the laboratory for analysis. Again, there was no structure on the tape to locate the mold sample thereon. Also, the tape still had to be further processed (transferred to the slide) for subsequent microscopic analysis.

### SUMMARY OF THE INVENTION

In response thereto I have provided an improved mold collection kit which includes a plurality of sticky test tapes with each test tape having a transparent window thereon. The transparent window defines a standardized boundary which circumscribes the desired mold sample. Upon aligning the window about the mold or other environmental sample and pressing the tape thereon, the mold sticks to the tape within the window. This tape is then attached to an enlarged, plastic microscopic slide, releasably attached to a mailing placard for transport to the laboratory. Indicia beneath the panel/slide directs alignment of the sticky test tape with a preselected area on the slide. The plastic slide with test tapes in a preselected relationship thereon is easily prepared for microscopic view upon placement on an agent thereon. Each test tape presents an end for user handling, displaced from the sample, which maintains the integrity of the mold sample during handling.

It is therefore a general object of the invention to provide an improved mold test kit.

Another object of the invention is to provide a test kit, as aforesaid, having a test tape therein, the test tape having structure thereon for directing the initial placement and subsequent location of the mold sample thereon.

A further object of the invention is to provide a mold sample with test tape, as aforesaid, the test tape having a sample window thereon wherein the mold sample is positioned.

Another object of this invention is to provide a test tape, as aforesaid, wherein the test tape includes a portion for user handling displaced from the mold sample.

A still further object of the invention is to provide a mold detection kit, as aforesaid, having a mailer for transport of the mold sample to the laboratory for analysis, the mailer including a microscopic-type slide for affixation of a plurality of test tapes thereon in a preselected relationship. The plastic microscopic-type slide will not break in the mail. By affixing the sample to the slide there is minimal chance that the contaminants present will be released to cause exposure to postal workers or others to the sampled constituents.

A further object of this invention is to provide a mold detection kit, as aforesaid, including means for aligning the test tapes on the slide in said preselected relationship.

A more particular object of this invention is to provide a mold detection kit, wherein the slide with test tapes, as aforesaid, is presented in a sequence for efficient and microscopic analysis.

Other objects and advantages of this invention will become apparent from the following description taken in connection with the accompanying drawings, wherein is set forth by way of illustration and example, a now preferred embodiment of this invention.

### BRIEF DESCRIPTION OF THE DRAWINGS

FIG. 1 is a plan view showing a plurality of removable test tapes affixed to a backing;

FIG. 2 is a plan view showing one test tape removed from the backing;

FIG. 3 is a view of the mailer with the plastic slide releasably affixed thereto and showing underlying alignment indicia;

FIG. 4 is a view of the mailer with the tapes affixed to the plastic slide in the preselected position as dictated by the alignment indicia; and

FIG. 5 illustrates the plastic slide with test tapes thereon as removed from the mailer.

### DESCRIPTION OF THE PREFERRED EMBODIMENT

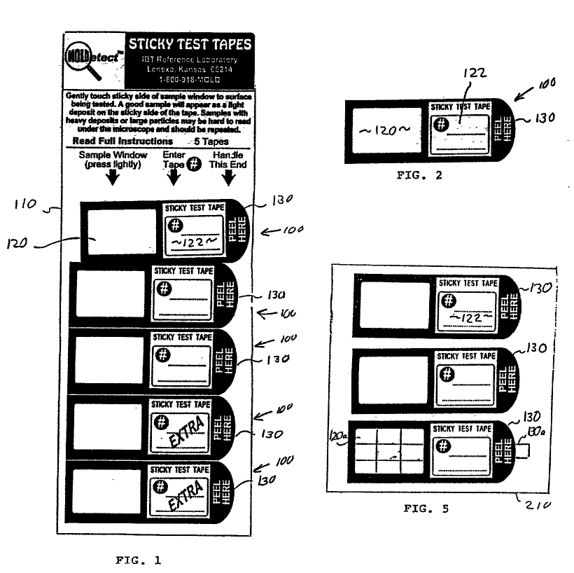

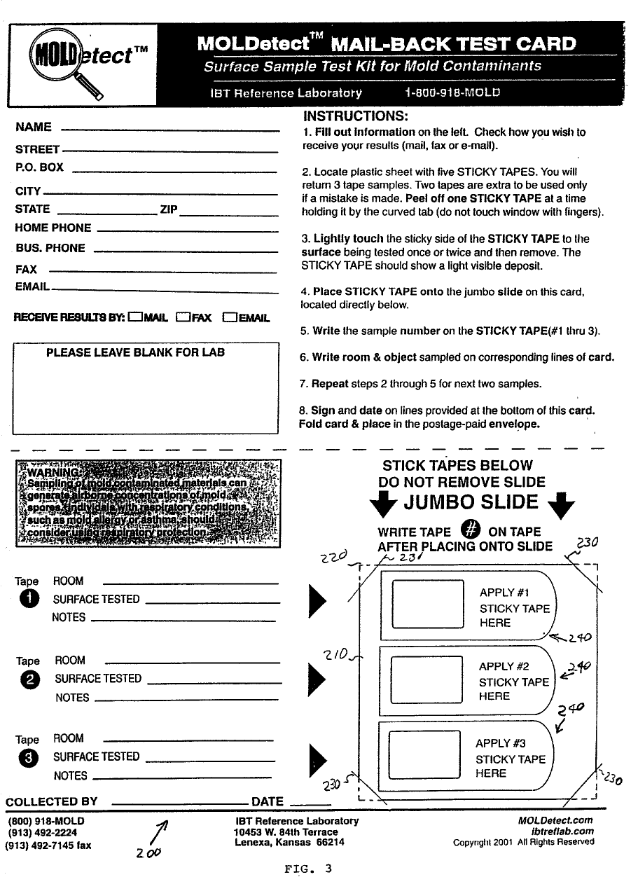

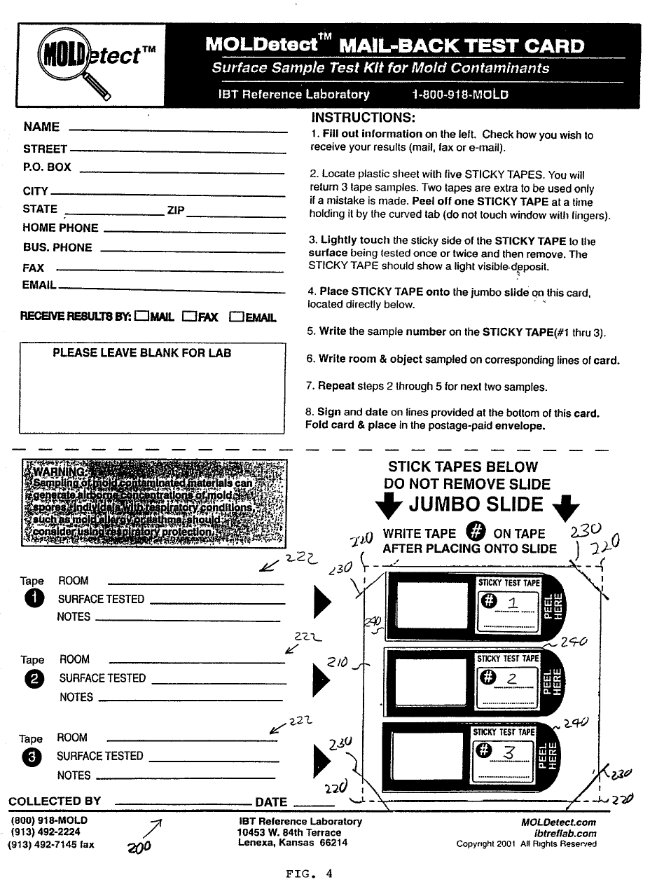

Turning more particularly to the drawings, FIG. 1 shows a plurality of test tapes 100 releasably affixed to a common carrier backing 110. (Top tape 100 is slightly displaced from its normal original position for purposes of illustration.) Each tape 100 includes a releasable adhesive on the surface adjacent the backing 110. The tape 100 also includes a transparent window 120 at one end with an area 122 adjacent thereto for recording information thereon. The opposed end 130, displaced from window 120, enhances user handling of the entire tape 100.

To collect a mold sample, the tape 100 is removed from the backing 110. The user places the window 120 about the desired mold sample. Upon lightly pressing the window 120 thereon the mold will be affixed to the window 120. Upon handling the test tape by end 130 the tape 100 is then transported to a plastic panel 210 which is affixed to the mailer 200 by insertion of the panel corners of panel 210 within slots 230 in the mailer. On the mailer are alignment indicia 240 underlying the plastic panel 210. The outlines of indicia 240 are generally congruent to the exterior perimeter of the test tape 100 and the window 120. Such indicia are viewable through the transparent panel 210. In FIG. 5 alignment has been generally achieved upon the tapes being affixed to the plastic panel 210. Upon tape alignment the tapes 100 and windows 120 thereon are in a preselected sequential order. Information can be recorded on the test tape at 122, e.g., tape number, and at mailer 222, such as the room and surface tested. The mailer is ready to be sent to the laboratory for analysis.

As shown in FIG. 5, the panel 210 is removable from the mailer 200. The panel is then prepared for microscopic viewing by depositing a drop of fungal stain on the collected specimen. As the preferred width of the panel 210 is the width of a standard microscopic slide, the user then places the panel on the microscope viewing table and view the three specimens one after another for mold analysis. Thus, panel 210 in effect acts as an enlarged microscopic slide with three specimens thereon in a predetermined longitudinal alignment.

Upon completion of the analysis the panel 210 is then returned to the mailer 200. Thus, the information on the test tapes 100 in area 122 is aligned with information 222 on the mailer 200. This coordination of information precludes subsequent mishandling and mis-separation of the tapes 100. Also, the combination of areas 122 and 222 allows a greater amount of information to be recorded relevant to the sample within window 120.

Once analyzed a laboratory report is then prepared and sent to the user identifying the mold and actions to be taken in response thereto.

FIG. 5 shows an alternative embodiment of my tape 130 as having a grid 120a within the windows 120. As such, a plurality of squares is presented by which the position of the identified objects in the specimen can be more easily initially defined and then subsequently relocated if need be. For example, the location of a spore of notable significance within the transparent window can now be mapped according to zones presented by the grid. Also, a count of spores per zone or zone size, e.g., square millimeters, can be more easily accomplished.

A non-stick tab 130a on the end of the test tape 130 is also provided. Thus, the tape can be more easily manipulated when depositing the stain on the collected specimen as this tab 130a precludes the tape from adhering to the hands or gloves of the user or adjacent surfaces.

It is to be understood that while certain forms of this invention have been illustrated and described, it is not limited thereto, except in so far as such limitations are included in the following claims to be set forth in the complete patent application once filed.

Having thus described the invention, what is claimed as new and desired to be secured by Letters Patent is:

1. A test kit for aid in identifying an environmental sample comprising:
a test tape having a surface with a releasable adhesive on one side thereof;
a window integral with said test tape comprising a material for viewing therethrough, said window adapted to collect an at least one environmental sample upon pressing said adhesive surface of said window against the sample;
a slide for affixation of said test tape with sample thereon, said affixation trapping said at least one environmental sample between said slide and said tape and within said window, said slide adapted for combination with a microscope, whereupon a view of said window through said microscope enlarges said at least one sample trapped within said window for analysis thereof.

2. The kit as claimed in claim 1 further comprising a placard having means for releasable storage of said slide thereon.

3. The kit as claimed in claim 1 wherein said window presents a grid therein, said grid defining a plurality of zones within said window for location of said at least one trapped sample within one of said zones.

4. The kit as claimed in claim 1 wherein said test tape further comprises a tab at one end thereof, said tab enhancing a user manipulation of said test tape.

5. The kit as claimed in claim 4 wherein said adhesive is displaced from said tab to further enhance said manipulation.

6. The kit as claimed in claim 1 further comprising means on said test tape for affixing information indicative of said at least one environmental sample thereon.

7. The kit as claimed in claim 2 further comprising means on said placard for affixing information indicative of said at least one environmental specimen thereon.

8. The kit as claimed in claim 1 wherein said slide is configured for affixation of a plurality of said test tapes thereon.

9. The kit as claimed in claim 2 wherein said placard is adapted for transport for subsequent combination of said slide thereon.

10. A method for collecting an environmental sample on a surface for subsequent analysis comprising the steps of:
providing a tape having a circumscribed window thereon, said window having a sticky adhesive on one side thereof;
circumscribing said window about an environmental sample on a surface;
pressing at least said window against the surface for adhesion of the environmental sample thereto;
displacing said window from said surface with the sample affixed to said window;
releasably attaching said test tape to a see through slide;
transporting said slide to a microscope;
preparing said slide for a microscopic analysis;
directing said microscope to said window; and
viewing the specimen within said window through said microscope for analysis.

11. The method as claimed in claim 10 wherein a plurality of test tapes are provided for repeated samples, said test tapes attached to said slide.

12. The method as claimed in claim 10 further comprising the steps of recording on said test tape information indicative of the environmental sample.

13. The method as claimed in claim 12 wherein said information includes a location of the environmental sample.

14. The method as claimed in claim 13 wherein the information includes a type of surface on which the environmental sample was found.

15. The method as claimed in claim 10 further comprising the steps of providing a grid in said window, said grid presenting a plurality of zones for location of the specimen within said window.

16. The method as claimed in claim 10 further comprising the step of releasably attaching said slide to a placard prior to said transporting strip.

17. The method as claimed in claim 16 further comprising the step of recording on said placard information indicative of the environmental sample.

18. The method as claimed in claim 17 wherein said information includes a location of the environmental sample.

19. A kit for collecting an environmental sample from a selected surface comprising:
at least one tape having a surface with a releasable adhesive thereon;
a window incorporated in said tape, said window presenting a perimeter for circumscribing an environmental sample upon pressing said window against the sample;
means on said window for affixing the sample thereto upon said pressing;
a slide adapted for affixation of said test tape with sample thereon, said window defining a viewing zone for the environmental sample positioned between said slide and said tape;
a placard for releasable affixation of said slide thereto;
means on said placard for a proper alignment of said test tape on said slide, a release of said slide from said placard presenting a slide for subsequent viewing through a microscope.

20. The kit as claimed in claim 19 wherein said placard is adapted for transport to a displaced location for said microscopic viewing.
